(19) United States
(12) Patent Application Publication
(10) Pub. No.: US 2025/0165151 A1
(43) Pub. Date: May 22, 2025

(54) APPARATUS AND METHOD FOR MANAGING DISAGGREGATED MEMORY BASED ON MEMORY ACCESS PATTERN RECOGNITION

(71) Applicant: ELECTRONICS AND TELECOMMUNICATIONS RESEARCH INSTITUTE, Daejeon (KR)

(72) Inventors: Chang-Dae KIM, Daejeon (KR); Kwang-Won KOH, Daejeon (KR); Tae-Hoon KIM, Daejeon (KR); Eun-Ji PAK, Daejeon (KR); Yeon-Jeong JEONG, Daejeon (KR)

(73) Assignee: ELECTRONICS AND TELECOMMUNICATIONS RESEARCH INSTITUTE, Daejeon (KR)

(21) Appl. No.: 18/950,435

(22) Filed: Nov. 18, 2024

(30) Foreign Application Priority Data
Nov. 20, 2023 (KR) 10-2023-0160264
Jul. 31, 2024 (KR) 10-2024-0101522

(51) Int. Cl. G06F 3/06

(52) U.S. Cl. CPC G06F 3/0613; G06F 3/0659; G06F 3/067

(57) ABSTRACT

Disclosed herein are an apparatus and method for managing a disaggregated memory based on memory access pattern recognition. The apparatus and method for managing a disaggregated memory based on memory access pattern recognition includes memory configured to store at least one program, and a processor configured to execute the program, wherein the program is configured to recognize a pattern of memory access to a disaggregated memory including a local memory and a remote memory of an application or a container and manage the disaggregated memory based on the recognized memory access pattern, and recognize memory access patterns for respective memory areas managed by at least one virtual memory area descriptor when the memory access pattern is recognized.

### CROSS REFERENCE TO RELATED APPLICATIONS

This application claims the benefit of Korean Patent Application Nos. 10-2023-0160264, filed Nov. 20, 2023 and 10-2024-0101522, filed Jul. 31, 2024, which are hereby incorporated by reference in their entireties into this application.

### BACKGROUND OF THE INVENTION

### 1. Technical Field

The following embodiments relate to technology for providing disaggregated memory suitable for the memory access pattern of an application or a container in a disaggregated memory environment.

### 2. Description of the Related Art

Resource disaggregation is technology for efficiently utilizing resources by sharing computing and memory resources of multiple computers.

Recently, a data center has been showing interest in providing various resource disaggregation technologies to efficiently use limited resources or idle resources within the data center. Among resource disaggregation technologies, disaggregated memory technology refers to technology intending to efficiently use memory resources by sharing memory resources of multiple different servers. Recently, memory usage for training and inference of large-scale artificial intelligence language models has heavily increased, and the requirement for disaggregated memory technology is also increasing with this trend.

In such a disaggregated memory system, memory may be classified into two types, that is, local memory that is the memory of a server for performing computing and remote memory that is the memory of servers for providing only memory without performing computing. Therefore, pieces of data required for computing may be stored and used in the local memory, and pieces of data that are not expected to be used in the near future may be transferred to and stored in the remote memory.

However, when an application requires data present in the remote memory in the disaggregated memory system, an operation may be continuously performed after the data present in the remote memory is transmitted to the local memory. Due thereto, because a considerably long time is required in order to access the remote memory compared to the local memory, the frequency of remote memory access may be a decisive factor in application performance. Therefore, in the disaggregated memory system, it is important to reduce the frequency of remote memory access.

Meanwhile, the memory access pattern of the application refers to a pattern indicating how a program accesses memory. When such a memory access pattern can be identified, the disaggregated memory system may decrease the frequency of remote memory access using the memory access pattern.

Representative examples of the type of memory access pattern of the application may include sequential access, random access, strided access, etc.

First, sequential access occurs when pieces of data are sequentially accessed at consecutive memory addresses. For example, this corresponds to the case where elements in an array are sequentially read from the beginning to the end.

Next, random access refers to the case where data is accessed from unpredictable arbitrary locations in memory. For example, when data is searched for in a data structure such as a linked list, a hash table, and a tree structure, random access may occur because pieces of data at various addresses allocated at different times are accessed without following a specific order.

Finally, strided access occurs when pieces of data having addresses at regular intervals are accessed in an array or a list. For example, the case where, in a two-dimensional (2D) array, all elements in a specific column are accessed may be included in strided access.

Further, in the disaggregated memory system, temporal locality also plays an important role. When specific data is frequently accessed within a short period of time, there is a strong possibility that disaggregated memory will maintain the corresponding data in local memory, with the result that the frequency of remote memory usage caused by access to the corresponding data decreases. Meanwhile, when specific data is accessed at intervals of a long time, there is a strong possibility that the disaggregated memory system will shift the corresponding data to the remote memory while access to the data does not occur, with the result that the frequency of remove memory usage increases.

Also, a memory device of a Compute Express Link (CXL) device or the like may have byte-addressability characteristics while being connected to and used with the remote memory. When this device is used as the remote memory, it may be advantageous to keep and use data that is accessed at intervals of a long time in the remote memory. Although the frequency of remote memory usage may be increased for the corresponding data, the local memory is not entirely used for the corresponding data, so that other pieces of data may occupy the local memory for a longer time, thus decreasing the frequency of remote memory usage.

Meanwhile, a method for managing memory in an operating system such as Linux is as follows. When an application or a container is initially created, the operating system allocates a memory descriptor for managing the entire memory used by the corresponding process. For example, in Linux, the memory descriptor has the name “mm_struct”.

Further, a virtual memory area descriptor for dividing and separately managing various types of virtual memory spaces used by the process is allocated to each memory area used by the process. The virtual memory area descriptor may be classified into virtual memory area descriptors for a code area, a global data area, a heap area, a stack area, etc.

When the application is allocated memory through a library function such as malloc() or mmap() a new virtual memory area descriptor may be assigned to the application for memory allocation. Alternatively, an area that is managed by an existing virtual memory area descriptor, but is not used may be allocated to the application. Alternatively, as an area that is managed by the existing virtual memory area descriptor is extended, the extended area may be allocated to the application.

Individual memory areas allocated to the application may belong to one virtual memory area descriptor. The sizes of the memory areas managed by respective virtual memory area descriptors may be different from each other, and all virtual memory area descriptors may belong to the memory descriptor of the corresponding process.

### SUMMARY OF THE INVENTION

An embodiment is intended to optimize the performance of an application and a container by managing local and remote memories suitable for the memory access pattern of the application or the container in a disaggregated memory system.

In accordance with an aspect, there is provided an apparatus for managing a disaggregated memory based on memory access pattern recognition, including a memory configured to store at least one program, and a processor configured to execute the program, wherein the program is configured to recognize a pattern of memory access to a disaggregated memory including a local memory and a remote memory of an application or a container and manage the disaggregated memory based on the recognized memory access pattern, and recognize memory access patterns for respective memory areas managed by at least one virtual memory area descriptor when the memory access pattern is recognized.

The program may be configured to assign a memory access pattern ID and a memory access pattern type of a virtual memory area descriptor newly created as a certain function is called from the application or the container.

The program may be configured to assign an identical memory access pattern ID and an identical memory access pattern type to a virtual memory area descriptor for a memory area corresponding to one of a code area or a stack area.

The program may be configured such that, as a process is duplicated to create a child process from a parent process through a fork function, a memory access pattern ID and a memory access pattern type identical to those of a duplication target virtual memory area descriptor are assigned to a virtual memory area descriptor that is duplicated together with the process.

The program may be configured to assign an identical memory access pattern ID and an identical memory access pattern type to memory areas allocated at an identical code location.

The program may be configured to optimize disaggregated memory performance based on a result of analyzing a memory access pattern type as a change in a page table is sensed by occurrence of a page fault or by a Memory Management Unit (MMU) notifier.

The program may be configured to change a transfer unit of data to be transmitted between the remote memory and the local memory in optimizing the disaggregated memory performance.

The program may be configured to prefetch data stored in the remote memory, predicted to be subsequently accessed depending on the memory access pattern, to the local memory in optimizing the disaggregated memory performance.

The program may be configured to pin data to one of the local memory or the remote memory in optimizing the disaggregated memory performance.

The program may be configured to, when the disaggregated memory is managed, fetch data in the remote memory, requested to be accessed, to the local memory and evict data in the local memory, expected to be less frequently used, to the remote memory when a space of the local memory is insufficient.

In accordance with another aspect, there is provided a method for assigning a memory access pattern ID and type, including analyzing a memory area that is newly allocated as a certain function is called from an application or a container, and assigning a memory access pattern ID and a memory access pattern type of a virtual memory area descriptor for managing memory areas based on a result of analysis.

Assigning the memory access pattern ID and the memory access pattern type may include assigning an identical memory access pattern ID and an identical memory access pattern type to a virtual memory area descriptor for a memory area corresponding to one of a code area or a stack area.

Assigning the memory access pattern ID and the memory access pattern type may include, as a process is duplicated to create a child process from a parent process through a fork function, assigning a memory access pattern ID and a memory access pattern type identical to those of a duplication target virtual memory area descriptor to a virtual memory area descriptor that is duplicated together with the process.

Assigning the memory access pattern ID and the memory access pattern type may include assigning an identical memory access pattern ID and an identical memory access pattern type to memory areas allocated at an identical code location.

In accordance with a further aspect, there is provided a method for managing a disaggregated memory based on memory access pattern recognition, including recognizing a pattern of memory access to a disaggregated memory including a local memory and a remote memory of an application or a container, and managing the disaggregated memory based on the recognized memory access pattern, wherein, when the memory access pattern is recognized, memory access patterns are recognized for respective memory areas managed by at least one virtual memory area descriptor.

The method may further include optimizing disaggregated memory performance based on a result of analyzing a memory access pattern type as a change in a page table is sensed by occurrence of a page fault or by a Memory Management Unit (MMU) notifier.

Optimizing the disaggregated memory performance may include changing a transfer unit of data to be transmitted between the remote memory and the local memory.

Optimizing the disaggregated memory performance may include prefetching data stored in the remote memory, predicted to be subsequently accessed depending on the memory access pattern, to the local memory.

Optimizing the disaggregated memory performance may include pinning data to one of the local memory or the remote memory.

Managing the disaggregated memory may include fetching data in the remote memory, requested to be accessed, to the local memory, and evicting data in the local memory, expected to be less frequently used, to the remote memory when a space of the local memory is insufficient.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic block configuration diagram of a system including an apparatus for managing disaggregated memory based on memory access pattern recognition of an application according to an embodiment;

FIG. 2 is a schematic block diagram illustrating the internal configuration of a memory access pattern ID and type manager according to an embodiment;

FIG. 3 is a flowchart for explaining a method for assigning a memory access pattern ID and type according to an embodiment;

FIG. 4 is a schematic block diagram illustrating the internal configuration of a disaggregated memory manager according to an embodiment;

FIG. 5 is a flowchart illustrating a page fault processing method according to an embodiment; and

FIG. 6 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will be described in detail with reference to the accompanying drawings. In the following description of the present disclosure, the same reference numerals are used to designate the same or similar elements throughout the drawings and repeated descriptions of the same components will be omitted.

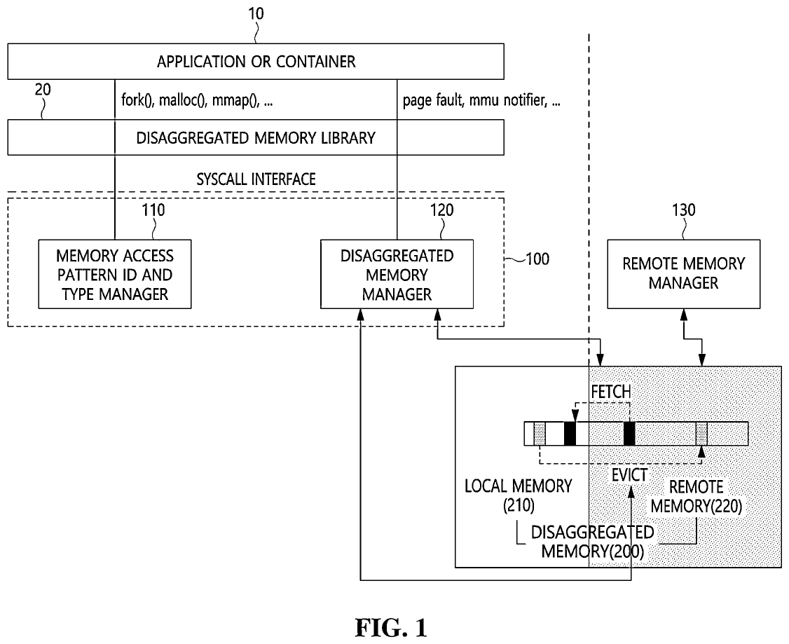

FIG. 1 is a schematic block configuration diagram of a system including an apparatus for managing disaggregated memory based on memory access pattern recognition according to an embodiment.

Referring to FIG. 1, an apparatus 100 for managing disaggregated memory based on memory access pattern recognition (hereinafter also referred to as an “apparatus”) recognizes the pattern of memory access by an application or container 10 to disaggregated memory 200, and manages the disaggregated memory 200 so that the performance of the application or container 10 can be optimized based on the recognized memory access pattern.

Here, the disaggregated memory 200 may include local memory 210 and remote memory 220.

Here, according to an embodiment, recognition of the memory access pattern may be performed on respective areas managed by virtual memory area descriptors.

The unit in which the application is allocated memory and the unit in which memory is managed by each virtual memory area descriptor are not identical to each other. However, it is difficult to determine the unit in which the application is allocated memory in the unit of an operating system in which the disaggregated memory system is typically implemented. Further, because the unit in which the application is allocated the memory may be small, a management burden may increase when the memory is managed depending on a memory allocation unit. Also, a library which takes charge of memory allocation of the application may allow pieces of data having similar attributes (e.g., an allocation request size, whether the corresponding memory area is for a memory area for an array, etc.) to be included in one virtual memory area descriptor, and may allow memories of different types (i.e., a code area, a global data area, a heap area, a stack area, or the like) to be included in different virtual memory area descriptors.

Therefore, identifying memory access patterns in units of virtual memory area descriptors enables efficient analysis of the memory access patterns to be performed while distinguishing each memory access pattern from the access patterns of other pieces of data.

However, in the disaggregated memory system, promptly analyzing memory access patterns and reflecting them in memory management policies is an important factor for performance improvement. Accordingly, tracking and analyzing memory access patterns for respective virtual memory area descriptors and then reflecting the results of tracking and analyzing in the memory management policies may deteriorate the performance of the disaggregated memory system during the analysis of the memory access patterns.

Therefore, in an embodiment, the apparatus 100 needs to be able to identify the memory access pattern type of a virtual memory area as quickly as possible.

For this operation, the apparatus 100 according to an embodiment may include a memory access pattern ID and type manager 110 and a disaggregated memory manager 120.

When a function of newly creating a virtual memory area descriptor, such as a memory allocation function malloc() or mmap() or a function fork() is called from the application or container 10, the memory access pattern ID and type manager 110 designates a memory access pattern ID and a memory access pattern type for the newly created virtual memory area descriptor.

Here, the memory access pattern ID and type manager 110 may assign one identical memory access pattern ID to the virtual memory area descriptions of multiple memory areas having a similar memory access pattern.

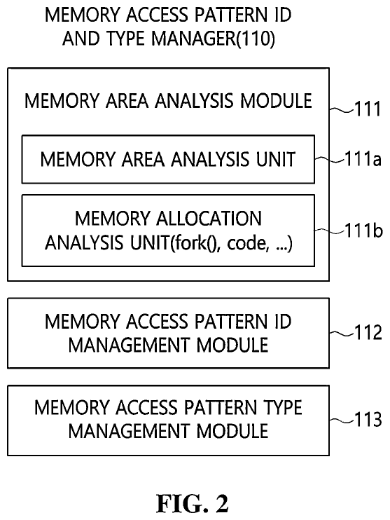

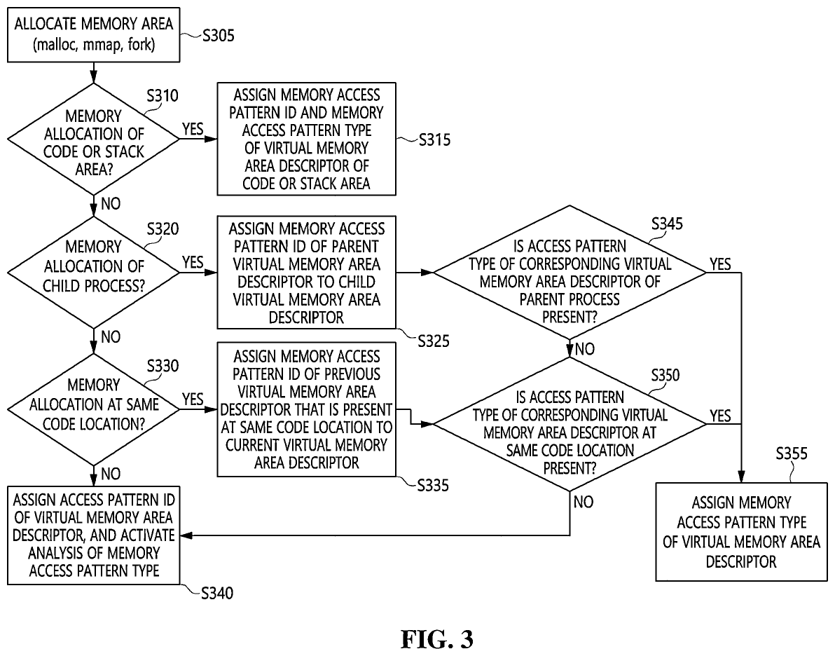

Detailed description thereof will be made later with reference to FIGS. 2 and 3.

When a page fault occurs in the application or container 10 or when a change in a page table is sensed by a Memory Management Unit (MMU) notifier, the disaggregated memory manager 120 performs disaggregated memory management by which the disaggregated memory 200 fetches data from remote memory 210, and also analyzes the type of the corresponding memory access pattern, thus performing optimization of disaggregated memory performance.

In this case, in an embodiment, virtual memory area descriptors expected to have similar memory access patterns may be grouped to analyze the memory access patterns.

That is, when the type of a specific memory access pattern is sensed in one memory area, at least one memory area having the same memory access pattern ID as the memory access pattern ID of the corresponding memory area is assumed to have the same memory access pattern as the corresponding memory area. By means of this process, even if memory access patterns are analyzed only for some memory areas, efficient disaggregated memory management policies may be used for more memory areas.

FIG. 2 is a schematic block diagram illustrating the internal configuration of a memory access pattern ID and type manager according to an embodiment, and FIG. 3 is a flowchart for explaining a method for assigning a memory access pattern ID and type according to an embodiment.

Referring to FIG. 2, the memory access pattern ID and type manager 110 may include a memory area analysis module 111, a memory access pattern ID management module 112, and a memory access pattern type management module 113. Detailed description of individual modules will be made below with reference to FIG. 3.

Referring to FIG. 3, when a memory allocation function, such as a malloc () or mmap () function, or a fork () function is called from the application or container 10, a memory area is allocated at step S305.

Here, a virtual memory area descriptor which will manage the allocated memory area is newly created, wherein the memory access pattern ID and type manager 110 assigns a memory access pattern ID to the newly created virtual memory area descriptor. Here, according to an embodiment, multiple virtual memory area descriptors may share the same memory access pattern ID with each other depending on various characteristics of the memory area.

First, the same memory access pattern ID may be assigned to virtual memory area descriptors corresponding to a specific type of memory area from which a memory access pattern can be easily inferred.

That is, when the memory area analysis module 111 analyzes the allocated memory area as a code or stack area at step S310, the memory access pattern ID management module 112 may assign the memory access pattern ID of a virtual memory area descriptor for the code or stack area to the newly created virtual memory area descriptor, and the memory access pattern type management module 113 may assign a memory access pattern type mapped to the memory access pattern ID at step S315.

This shows that, in the case of the code area, there is a strong possibility that the memory access pattern type will be sequential access and that access will frequently occur. Therefore, a specific memory access pattern ID may be assigned to the code area, and disaggregated memory management policies for the code area may be established without separate analysis.

Further, in the case of the stack area, local variables used by functions of the application are mainly stored, and thus temporal locality is very high.

Further, when a function is called, it may be predicted that the stack area will be extended in a specific direction, whereas when a function is returned, it may be predicted that a previously used stack area will be accessed. Here, because the area extended by calling the function is a newly allocated area, there is no possibility that data will be present in the remote memory 220 of the disaggregated memory 200, and thus separate management policies are not required.

On the other hand, when the function is returned, a memory area in a specific direction (i.e., a direction corresponding to a larger address value in the case of Linux) will be used depending on the type of operating system, with the result that prefetching for the corresponding area may be performed. Therefore, stack areas may share the specific memory access pattern ID with each other.

Next, when a process is duplicated through a fork() function to create a child process from a parent process, a virtual memory area descriptor is also duplicated. Here, the same memory access pattern ID as a duplication target virtual memory area descriptor may be assigned to the duplicated virtual memory area descriptor. The reason for this is that the two forked processes will execute the same code, and thus the memory areas in the parent process and the child process are likely to exhibit the same memory access pattern type.

That is, when the memory area analysis module 111 analyzes the allocated memory area as the area corresponding to the child process at step S320, the memory access pattern ID management module 112 may equally assign the memory access pattern ID of the parent virtual memory area descriptor to the child virtual memory area descriptor at step S325.

Finally, the memory areas allocated at the same code location may be assigned the same memory access pattern ID. The reason for this is that, when memory allocation present at a specific location in the code is repeatedly executed by a repetitive statement or the like, the corresponding memory areas are highly likely to have the same type of data in terms of meaning, and thus the allocated memory areas have a strong possibility of having the same memory access pattern type.

Therefore, when the memory area analysis module 111 determines the allocated memory area to be an area corresponding to the same code location at step S330, the memory access pattern ID management module 112 may assign the memory access pattern ID of a previous virtual memory area descriptor that is present at the same code location to the current virtual memory area descriptor at step S335.

On the other hand, when allocation of memory areas corresponds to none of memory allocation of the code or stack area, memory allocation of a child process, and memory allocation at the same code location as the results of determination at steps S310, S320 and S330, the memory access pattern ID management module 112 assigns the access pattern ID of the virtual memory area descriptor, and activates the analysis of a memory access pattern type by the memory area analysis module 111 at step S340.

As described above, when multiple virtual memory area descriptors share the same memory access pattern ID, there is an advantage in that optimization of disaggregated memory performance for each memory area may be more promptly applied.

For example, when a specific process is executed to analyze memory access patterns for respective memory areas, and then a fork function for the corresponding process is executed, a forked process (child process) shares the memory access pattern ID of the corresponding memory area in a parent process.

Meanwhile, the memory access pattern type management module 113 determines whether the memory access pattern type of the virtual memory area descriptor of the parent process is present at step S345.

When it is determined at step S345 that the memory access pattern type of the virtual memory area descriptor of the parent process is present, the memory access pattern type management module 113 equally assigns the memory access pattern type of the virtual memory area descriptor of the parent process as the memory access pattern type of the virtual memory area descriptor of the child process at step S355.

Accordingly, the child process shares the memory access pattern type of the corresponding memory area in the parent process with the parent process. Then, optimization of disaggregated memory performance may be immediately applied to memory areas in the child process in accordance with the result of analysis of the memory area in the parent process even before the memory access pattern type is analyzed.

On the other hand, when it is determined at step S345 that the memory access pattern type of the virtual memory area descriptor of the parent process is not present or after step S335 is performed, the memory access pattern type management module 113 determines whether the memory access pattern type of the virtual memory area descriptor corresponding to the same code location is present at step S350.

When it is determined at step S350 that the memory access pattern type of the virtual memory area descriptor corresponding to the same code location is present, the memory access pattern type management module 113 assigns the memory access pattern type of the corresponding virtual memory area descriptor at step S355.

On the other hand, when it is determined at step S350 that the memory access pattern type of the virtual memory area descriptor corresponding to the same code location is not present, the memory access pattern ID and type manager 110 proceeds to step S340 of assigning the memory access pattern ID of the virtual memory area descriptor and of analyzing the memory access pattern type to determine the memory access pattern type.

By means of this process, optimization of disaggregated memory performance, simultaneously with execution of the process, may be applied to the code area, the stack area or the like.

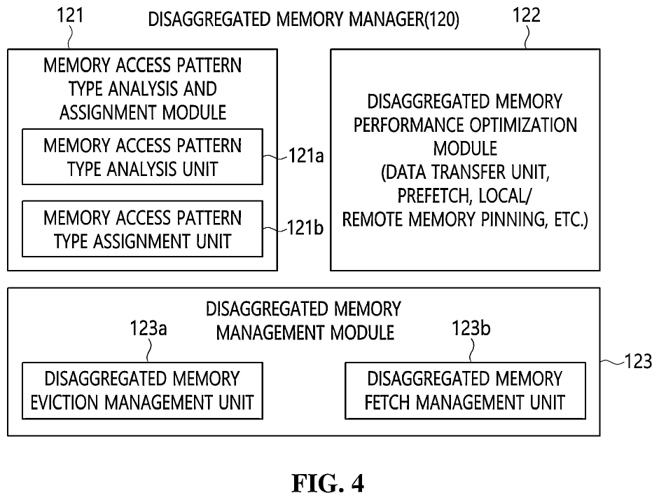

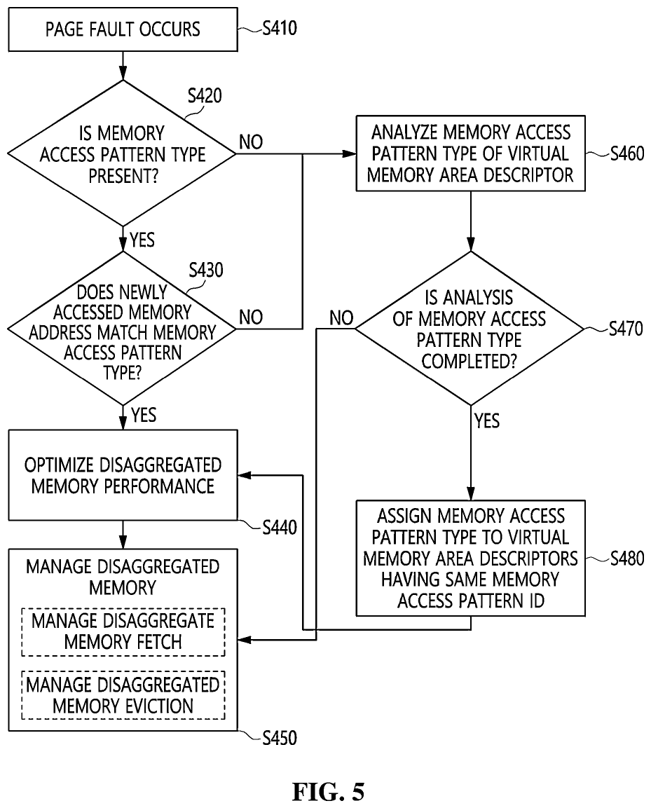

FIG. 4 is a schematic block diagram illustrating the internal configuration of a disaggregated memory manager according to an embodiment, and FIG. 5 is a flowchart for explaining a page fault processing method according to an embodiment.

Referring to FIG. 4, the disaggregated memory manager 120 according to the embodiment may include a memory access pattern type analysis and assignment module 121, a disaggregated memory performance optimization module 122, and a disaggregated memory management module 123. Detailed description of individual modules will be made below with reference to FIG. 5.

Referring to FIG. 5, as a page fault occurs at step S410, the memory access pattern type analysis and assignment module 121 of the disaggregated memory manager 120 may determine whether a previously analyzed memory access pattern type is present at step S420.

When it is determined at step S420 that the previously analyzed memory access pattern type is present, the memory access pattern type analysis and assignment module 121 checks whether a newly accessed memory address matches the previously analyzed memory access pattern type at step S430.

When it is checked at step S430 that the newly accessed memory address corresponds to memory access matching the previously analyzed memory access pattern type, the disaggregated memory performance optimization module 122 of the disaggregated memory manager 120 performs performance optimization for the disaggregated memory at step S440. Detailed description of step S440 will be made later.

On the other hand, when it is determined at step S420 that a previously analyzed memory access pattern type is not present, or when it is checked at step S430 the newly accessed memory address does not match the memory access pattern type, the memory access pattern type analysis and assignment module 121 newly analyzes the memory access pattern type at step S460. Here, the operation of the disaggregated memory performance optimization module 122 may be deferred.

Thereafter, when the analysis of the new memory access pattern type is completed at step S470, the memory access pattern type analysis and assignment module 121 assigns the same memory access pattern type to virtual memory area descriptors having the same memory access pattern ID at step S480, and then proceeds to step S440 of operating the disaggregated memory performance optimization module 122.

Finally, the disaggregated memory management module 123 of the disaggregated memory manager 120 manages disaggregated memory at step S550. For example, when the accessed memory area is present in remote memory, data is fetched from the remote memory. Also, when a local memory space is further required in order to fetch data, eviction of selecting data that is not expected to be frequently used from among pieces of data present in the local memory and evicting the selected data to the remote memory is performed.

Next, step S440 of optimizing disaggregated memory performance depending on the memory access pattern type, performed by the disaggregated memory performance optimization module 122 according to an embodiment, will be described in detail.

First, when accessing the remote memory, a transfer unit in which data is fetched to the local memory at the time of accessing the remote memory may be changed. The memory management unit of a typical operating system is 4 KB. The disaggregated memory system may manage memory using the same unit.

That is, when an application accesses a virtual memory address at which data is present only in remote memory, data having a size of 4 KB including the corresponding address is shifted to the local memory, after which the application may use the shifted data. Further, data may be transmitted in units of 4 KB even when data that is expected to be less frequently used among pieces of data in the local memory is shifted to the remote memory.

However, according to an embodiment, the disaggregated memory system may change the unit to 16 KB, 128 KB or the like rather than 4 KB. That is, when the application accesses a virtual memory address at which data is present only in the remote memory, data having a size of 16 KB or 128 KB including the corresponding address is shifted to the local memory, after which the application may use the shifted data. The unit of evicted data may be managed at various sizes even when data in the local memory is evicted to the remote memory.

Here, when a data transfer unit is larger, an application that performs sequential access may be deferred in performance. When a large amount of data is shifted at once when accessing a specific address in the remote memory and needing to shift data to the local memory, pieces of data may be sequentially accessed through sequential access, and thus the number of accesses to the remote memory may be reduced.

However, in the case of random access, even if the data transfer unit increases, there is a strong possibility of accessing the address of a farther location, and the number of accesses to the remote memory is not reduced. Further, as a data transfer unit increases, only a delay time for each remote memory access and bandwidth consumption by the remote memory are further increased. Furthermore, in order to fetch more data to the local memory, more data among pieces of data previously present in the local memory needs to be evicted to the remote memory, and thus the rate of data access to the local memory is further reduced.

Second, data in the remote memory may be prefetched. Based on the determined memory access pattern, data predicted to be subsequently accessed is shifted in advance to the local memory. For example, in the case of strided access, when the application accesses a specific address of a memory area having a strided access pattern, it may be predicted that data farther away from the corresponding address by specific bytes will be accessed, and thus data at the address to which access is predicted may be immediately shifted to the local memory. Then, when actually accessing the address to which access is predicted, remote memory access may not be required, and data transmission to the local memory has already started, and thus the wait time for data transmission may be shortened.

Third, data may be pinned to the local memory. When the frequency of memory access to a specific memory area is much higher than those of other areas, the corresponding area is pinned to the local memory and data therein is not evicted to the remote memory, thus decreasing the entire frequency of remote memory access by the application.

Fourth, data may be pinned to the remote memory. This is a policy limited to the case where a device, such as a CXL device, that can be used as remote memory, but is capable of providing byte-addressability is used. When a specific memory area exhibits a random access pattern while having a low memory access frequency, the size of data to be actually used may be very small even if data of a specific unit size (4 KB, 16 KB, or 128 KB) including the corresponding address is transmitted to the local memory. For example, an example of this case may be the word unit of a CPU (32 bits or 64 bits), and only a data structure having a size smaller than the size of the cache line of the CPU may be used. In this case, a remote memory access task may be sufficiently performed merely by loading only data having the size of the CPU cache line from the remote memory directly onto a CPU cache memory and performing task on the data. Furthermore, unless data is shifted to the local memory, data already present in the local memory does not need to be shifted to the remote memory, and thus a probability that data present in the local memory will be reused increases, and transmission to the remote memory is reduced, with the result that the total amount of I/O may be decreased.

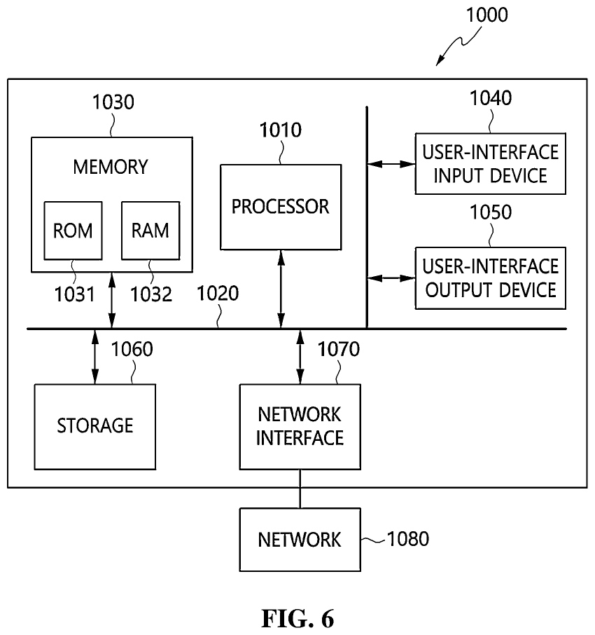

FIG. 6 is a diagram illustrating the configuration of a computer system according to an embodiment.

At least one of an apparatus 100 for managing disaggregated memory based on memory access pattern recognition, a memory access pattern ID and type manager 110 or a disaggregated memory manager 120, or a combination thereof may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

Specific executions described in the present disclosure are embodiments, and the scope of the present disclosure is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present disclosure.

According to embodiments, the performance of an application and a container may be optimized by managing local and remote memories suitable for the memory access pattern of the application or the container in a disaggregated memory system.

According to embodiments, the unit of a memory management block may be adjusted depending on the memory access pattern, and the performance of an application or a container in a disaggregated memory environment may be improved through technology for managing memories so that data that is frequently used is maintained in the local memory and data that is less frequently used is easily evicted to the remote memory.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. An apparatus for managing a disaggregated memory based on memory access pattern recognition, comprising:
a memory configured to store at least one program; and
a processor configured to execute the program,
wherein the program is configured to:
recognize a pattern of memory access to a disaggregated memory including a local memory and a remote memory of an application or a container and manage the disaggregated memory based on the recognized memory access pattern, and
recognize memory access patterns for respective memory areas managed by at least one virtual memory area descriptor when the memory access pattern is recognized.

2. The apparatus of claim 1, wherein the program is configured to assign a memory access pattern ID and a memory access pattern type of a virtual memory area descriptor newly created as a certain function is called from the application or the container.

3. The apparatus of claim 2, wherein the program is configured to assign an identical memory access pattern ID and an identical memory access pattern type to a virtual memory area descriptor for a memory area corresponding to one of a code area or a stack area.

4. The apparatus of claim 2, wherein the program is configured such that, as a process is duplicated to create a child process from a parent process through a fork function, a memory access pattern ID and a memory access pattern type identical to those of a duplication target virtual memory area descriptor are assigned to a virtual memory area descriptor that is duplicated together with the process.

5. The apparatus of claim 2, wherein the program is configured to assign an identical memory access pattern ID and an identical memory access pattern type to memory areas allocated at an identical code location.

6. The apparatus of claim 1, wherein the program is configured to optimize disaggregated memory performance based on a result of analyzing a memory access pattern type as a change in a page table is sensed by occurrence of a page fault or by a Memory Management Unit (MMU) notifier.

7. The apparatus of claim 6, wherein the program is configured to change a transfer unit of data to be transmitted between the remote memory and the local memory in optimizing the disaggregated memory performance.

8. The apparatus of claim 6, wherein the program is configured to prefetch data stored in the remote memory, predicted to be subsequently accessed depending on the memory access pattern, to the local memory in optimizing the disaggregated memory performance.

9. The apparatus of claim 6, wherein the program is configured to pin data to one of the local memory or the remote memory in optimizing the disaggregated memory performance.

10. The apparatus of claim 6, wherein the program is configured to, when the disaggregated memory is managed, fetch data in the remote memory, requested to be accessed, to the local memory and evict data in the local memory, expected to be less frequently used, to the remote memory when a space of the local memory is insufficient.

11. A method for assigning a memory access pattern ID and type, comprising:
analyzing a memory area that is newly allocated as a certain function is called from an application or a container; and
assigning a memory access pattern ID and a memory access pattern type of a virtual memory area descriptor for managing memory areas based on a result of analysis.

12. The method of claim 11, wherein assigning the memory access pattern ID and the memory access pattern type comprises:
assigning an identical memory access pattern ID and an identical memory access pattern type to a virtual memory area descriptor for a memory area corresponding to one of a code area or a stack area.

13. The method of claim 11, wherein assigning the memory access pattern ID and the memory access pattern type comprises:
as a process is duplicated to create a child process from a parent process through a fork function, assigning a memory access pattern ID and a memory access pattern type identical to those of a duplication target virtual memory area descriptor to a virtual memory area descriptor that is duplicated together with the process.

14. The method of claim 11, wherein assigning the memory access pattern ID and the memory access pattern type comprises:
assigning an identical memory access pattern ID and an identical memory access pattern type to memory areas allocated at an identical code location.

15. A method for managing a disaggregated memory based on memory access pattern recognition, comprising:
recognizing a pattern of memory access to a disaggregated memory including a local memory and a remote memory of an application or a container; and
managing the disaggregated memory based on the recognized memory access pattern,
wherein, when the memory access pattern is recognized, memory access patterns are recognized for respective memory areas managed by at least one virtual memory area descriptor.

16. The method of claim 15, further comprising:
optimizing disaggregated memory performance based on a result of analyzing a memory access pattern type as a change in a page table is sensed by occurrence of a page fault or by a Memory Management Unit (MMU) notifier.

17. The method of claim 16, wherein optimizing the disaggregated memory performance comprises:
changing a transfer unit of data to be transmitted between the remote memory and the local memory.

18. The method of claim 16, wherein optimizing the disaggregated memory performance comprises:
prefetching data stored in the remote memory, predicted to be subsequently accessed depending on the memory access pattern, to the local memory.

19. The method of claim 16, wherein optimizing the disaggregated memory performance comprises:
pinning data to one of the local memory or the remote memory.

20. The method of claim 16, wherein managing the disaggregated memory comprises:
fetching data in the remote memory, requested to be accessed, to the local memory, and evicting data in the local memory, expected to be less frequently used, to the remote memory when a space of the local memory is insufficient.
